(19) United States
(12) Patent Application Publication
(10) Pub. No.: US 2014/0255773 A1
(43) Pub. Date: Sep. 11, 2014

(54) ADDITIVE OF ELECTROLYTE OF LITHIUM BATTERY AND ELECTROLYTE OF LITHIUM BATTERY USING THE SAME

(71) Applicant: Formosa Plastics Corporation, KAOHSIUNG CITY (TW)

(72) Inventors: WAN TUN HUNG, Kaohsiung (TW); MING CHENG SHEN, Kaohsiung (TW); CHUN YEN LIU, Kaohsiung (TW); CHI CHANG HUNG, Kaohsiung (TW)

(73) Assignee: Formosa Plastics Corporation, KAOHSIUNG CITY (TW)

(21) Appl. No.: 14/199,171

(22) Filed: Mar. 6, 2014

(30) Foreign Application Priority Data
Mar. 8, 2013 (TW) 102108241

(51) Int. Cl. H01M 10/42

(52) U.S. Cl. CPC H01M 10/4235
USPC 429/199; 429/188; 558/455; 568/566

(57) ABSTRACT

An additive of an electrolyte of a lithium battery at least includes an initiator, where the initiator is decomposed at a temperature higher than a default temperature to generate free radicals. Also disclosed is an electrolyte of a lithium battery, at least including the above additive, carbonates, and a lithium salt.

### CROSS-REFERENCE TO RELATED APPLICATION

This application claims the benefit of Taiwan Patent Application No. 102108241, filed on Mar. 8, 2013, which is hereby incorporated by reference for all purposes as if fully set forth herein.

### BACKGROUND OF THE INVENTION

1. Field of Invention

The present invention relates to an additive of an electrolyte of a lithium battery and an electrolyte of a lithium battery using the same, and in particular, to an additive of an electrolyte of a lithium battery capable of effectively alleviating a temperature rise of the lithium battery and preventing explosion and fire, and an electrolyte of a lithium battery using the same.

2. Related Art

Nowadays, with the scientific and technological progress, it is of urgent necessity to provide a large quantity of power supplies for various consumer electronics, and the lithium battery is generally regarded as an optimal solution. The lithium battery is light in weight, has high charging efficiency, and barely suffers from a memory effect; with these advantages, the lithium battery becomes an indispensible product in these days.

However, a liquid electrolyte of the lithium battery has been criticized for the poor safety thereof. The electrolyte of the lithium battery is easily decomposed and hence generates carbon dioxide (CO₂) gas at a high temperature or when the battery is overcharged, causing gassing and liquid leakage of the lithium battery and shortening the cycle life; or, due to the low-flash solvent used in the lithium battery, when the temperature is higher than the flash of the solvent, the lithium battery may burst into flames, causing thermal runaway, and endangering the user.

### SUMMARY OF THE INVENTION

To solve the above problem and improve the safety of a lithium battery, the present invention provides an additive of a lithium battery and an electrolyte of a lithium battery using the same. The safety of the electrolyte of a lithium battery is improved while original charging and discharging characteristics of the lithium battery are not affected, preventing the lithium battery from bursting into flames when being inappropriately used.

An additive of an electrolyte of a lithium battery according to the present invention at least includes an initiator, where the initiator is decomposed at a temperature higher than a default temperature to generate free radicals.

An electrolyte of a lithium battery according to the present invention at least includes the above additive, a carbonate, and a lithium salt.

In the present invention, the initiator is used as an additive of an electrolyte of a lithium battery. When the lithium battery is inappropriately used, energy is accumulated, causing the temperature of the lithium battery to rise. When the temperature is approximately higher than 70° C., a polymerization reaction is started in the initiator-containing electrolyte of the lithium battery, which effectively hinders the transmission speed of lithium ions and therefore alleviates the temperature rise of the lithium battery, thus protecting the lithium battery from gassing and liquid leakage, or explosion and fire, and thermal runaway, and guaranteeing user safety. The battery safety is significantly enhanced.

Generally, the dosage of the additive may not exceed 5 wt %. Reactions inside the lithium battery are intricate and complex. The principal component of the electrolyte may be ethylene carbonate (EC), and ethylene is easily generated during the charging and discharging process. Reference may be made to the following reaction formula:

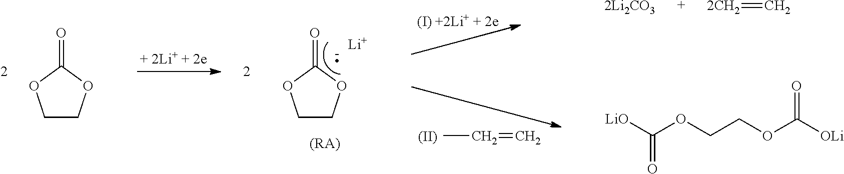

Or, at a high temperature, ester exchange easily happens in a chain carbonate to generate ethylene. Reference may be made to the following reaction formula:

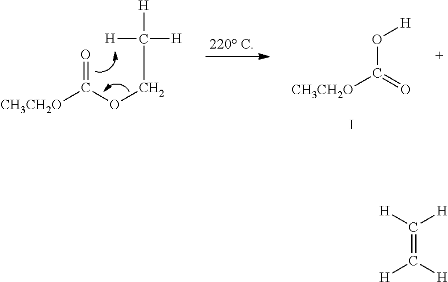

Therefore, the present invention utilizes a polymerization reaction between the ethylene generated inside the lithium battery and the added initiator such as azodiisobutyronitrile (AIBN) or benzoyl peroxide (BPO). That is, when the lithium battery is inappropriately used, for example, being overcharged, and the temperature of the lithium battery exceeds 70° C., the polymerization reaction is enabled, so as to lower the dispersion speed of lithium ions, inhibit chain reactions and prevent explosion and fire, and thermal runaway.

In addition, after the initiator such as AIBN or BPO is added to the electrolyte of the lithium battery, the electrolyte of the lithium battery easily generates free radicals, impeling the cyclic carbonate to open the cycle to form a Solid Electrolyte Interphase (SEI) of polycarbonate, which effectively promotes the forming of the SEI film and lowers the impedance of the SEI film. The SEI polymer also forms a protection film layer at an anode, so as to prevent transition metal ions from being precipitated.

### BRIEF DESCRIPTION OF THE DRAWINGS

FIG. 1 is a differential scanning calorimetry (DSC) thermal analysis diagram showing a comparison between thermal properties before and after an initiator is added to an electrolyte of a lithium battery.

FIG. 2 is an analysis diagram of charging and discharging characteristics of a lithium battery according to a third embodiment of the present invention;

FIG. 3 is an analysis diagram of charging and discharging characteristics of a lithium battery according to a fourth embodiment of the present invention;

FIG. 4 is an analysis diagram of alternating current impedance of an SEI film of a lithium battery according to a third embodiment of the present invention;

FIG. 5a is an X-ray photoelectron spectroscopy (XPS) analysis diagram of a cobalt component on an anode surface of a lithium battery according to a third embodiment of the present invention;

FIG. 5b is an XPS analysis diagram of a nitrogen component on an anode surface of a lithium battery according to a third embodiment of the present invention;

FIG. 5c is an XPS analysis diagram of an oxygen component on an anode surface of a lithium battery according to a third embodiment of the present invention; and

FIG. 6 is diagram of an overcharge safety verification on a lithium battery according to a fourth embodiment of the present invention.

### DETAILED DESCRIPTION OF THE INVENTION

To fully illustrate the present invention, embodiments of the present invention are elaborated in great details with reference to the accompanying drawings, so that those skilled in the art can easily implement the present invention. However, the spirit and scope of the present invention may be implemented in various forms, and the present invention is not limited to the spirit and scope of the specification.

In the specification, the description of including or having some components shall be construed as including or having aforesaid components only, or including or having other components; and these components are not specifically limited.

The characteristics and implementation of the present invention are described in detail below with reference to the accompanying drawings and optimal embodiments.

An additive of an electrolyte of a lithium battery according to the present invention at least includes an initiator, where the initiator is decomposed at a temperature higher than a default temperature to generate free radical; and the initiator has a functional group of —N═N— or —O—O—; the initiator is AIBN or BPO; the default temperature is approximately 60-120° C.

An electrolyte of a lithium battery according to the present invention at least includes the above additive, a carbonate, and a lithium salt, where the carbonate is selected from the group consisting of a cyclic carbonate, a chain carbonate, and an ester derivative; the carbonate is selected from the group consisting of ethyl methyl carbonate (EMC), diethyl carbonate (DEC), dimethyl carbonate (DMC), EC, propylene carbonate (PC), and γ-butyrolactone (GBL); the lithium salt is selected from lithium salts with a central atom being selected from the group consisting of C, N, B, and Al; the lithium salt is selected from the group consisting of LiPF6, LiBOB, LiBF4, and LiClO4; content of the additive accounts for 0.05˜10 wt % of the total electrolyte of the lithium battery

The AIBN is used as an initiator, and 2 wt % of AIBN is added into an electrolyte of a lithium battery; the electrolyte of the lithium battery is a mixture of EC and DEC at a ratio of 3:5 together with 0.8 M of the lithium salt, hence forming an electrolyte of a lithium battery according to a first embodiment of the present invention.

The AIBN is used as an initiator, 0.5 wt % of AIBN is added into an electrolyte of a lithium battery; the electrolyte of the lithium battery is a mixture of EC and DEC at a ratio of 3:5 together with 0.8 M of the lithium salt, hence forming an electrolyte of a lithium battery according to a second embodiment of the present invention.

The electrolyte of the lithium battery according to the second embodiment of the present invention is made into a LiCoO₂/Li button half cell, hence forming a lithium battery according to a third embodiment of the present invention.

The electrolyte of the lithium battery according to the second embodiment of the present invention is made into a LiCoO₂/SLC 18650 cylindrical battery, hence forming a lithium battery according to a fourth embodiment of the present invention, where the 18650 cylindrical battery is a common battery specification used in notebook computers.

Analyses are carried out by using instruments such as a DSC, so as to verify the efficacy of the present invention. Analysis results are described as follows:

DSC Thermal Stability Analysis

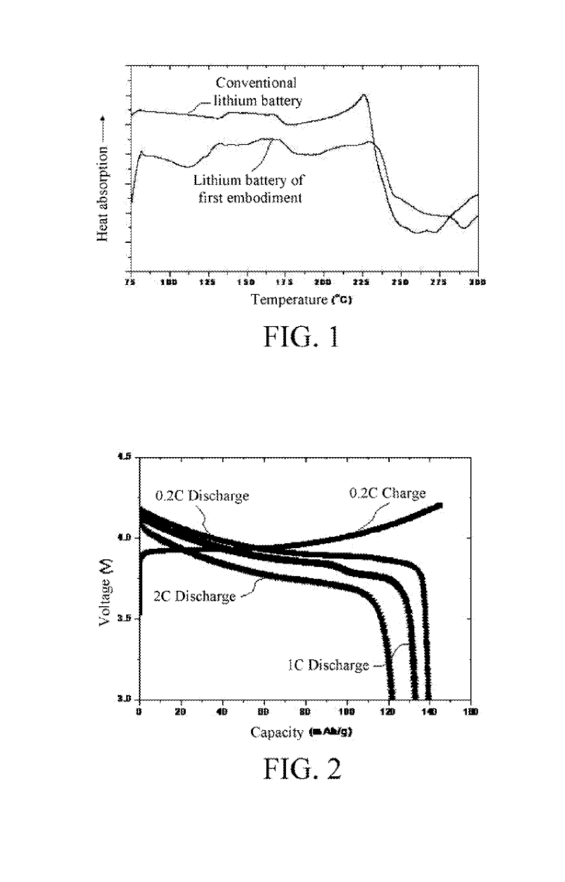

A DSC is used and the temperature is raised at a speed of 3° C./min, to analyze an initial temperature of a polymerization reaction in the AIBN-containing electrolyte of the lithium battery added. FIG. 1 is a DSC thermal analysis diagram showing a comparison between thermal properties before and after an initiator is added to an electrolyte of a lithium battery. FIG. 1 indicates that the electrolyte, added with 2 wt % of AIBN, of the lithium battery according to the first embodiment of the present invention has an exothermic peak at 80° C., which is an initial temperature of the electrolyte of the lithium battery according to the first embodiment of the present invention. In comparison, a conventional electrolyte of a lithium battery not added with an initiator does not have an exothermic peak, that is, the conventional electrolyte does not have an initial temperature. Because the polymerization reaction is an exothermic reaction, it indicates that electrolyte of the lithium battery according to the first embodiment of the present invention undergoes a polymerization reaction at 80° C.; on the contrary, the conventional electrolyte of the lithium battery not added with an initiator does not undergo a polymerization reaction.

In addition, FIG. 1 also indicates that at the temperature 225° C., the conventional electrolyte of the lithium battery has another exothermic peak, which proves that a decomposition reaction of the conventional electrolyte of the lithium battery is started. The decomposition reaction includes ester exchange of a carbonate, and the splitting of the lithium salt and the solvent. The decomposition reaction of the electrolyte of the lithium battery according to the first embodiment, on the other hand, happens at 235° C. Therefore, the addition of the additive can effectively improve the heat-resistance temperature of the electrolyte of the lithium battery.

The electrolyte of the lithium battery according to the first embodiment of the present invention undergoes a polymerization reaction, and the overall molecular weight is greater than that of the conventional electrolyte of the lithium battery. Therefore, the polymerization reaction of the electrolyte of the lithium battery according to the first embodiment of the present invention retards the decomposition reaction, so that the exothermic reaction slows down and is slower than the exothermic reaction in the conventional lithium battery. Hence, the thermal stability of the electrolyte of the lithium battery according to the first embodiment of the present invention is enhanced.

Analysis on Battery Charging and Discharging Characteristics

The battery charging and discharging characteristics of the lithium battery according to the third embodiment of the present invention and the lithium battery according to the fourth embodiment of the present invention are analyzed, so as to verify the charging and discharging feasibility after the initiator is added into the electrolyte of the lithium battery.

Referring to FIG. 2, FIG. 2 is an analysis diagram of charging and discharging characteristics of a lithium battery according to a third embodiment of the present invention. AIBN is added into the electrolyte of the lithium battery according to the third embodiment of the present invention, and the electrical property of the lithium battery according to the third embodiment of the present invention is verified. The theoretical capacity of the lithium-cobalt-oxide anode material is 160 mAh/g (capacity per gram). The electrolyte of the lithium battery according to the third embodiment of the present invention can be charged and discharged normally at a room temperature. The capacity is 140 mAh/g when the discharge current is 0.2 C, and more than 80% of the capacity is still maintained when the discharge current is 2 C. Therefore, the presence of the AIBN does not affect the battery features at the room temperature. In other words, the polymerization reaction of the AIBN will not be induced at the room temperature.

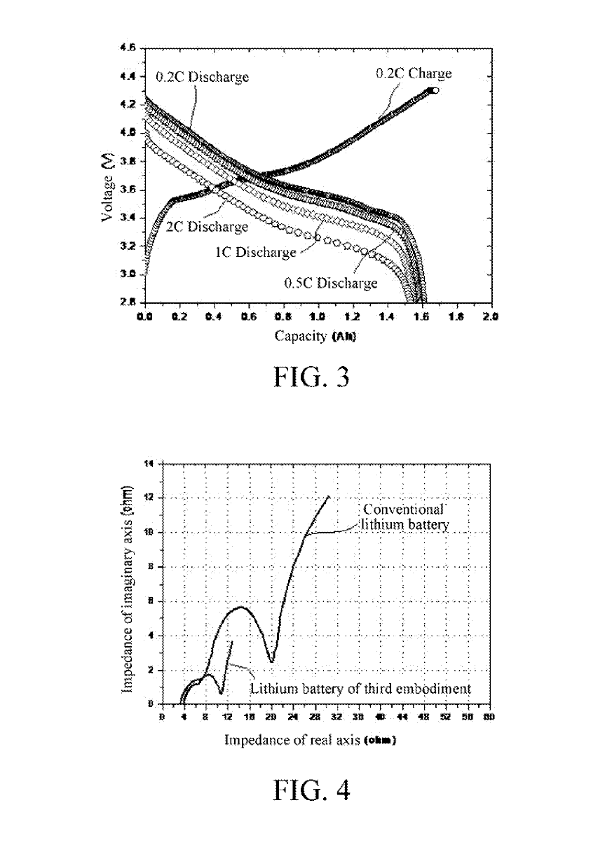

In verification of a 18650 cylindrical battery, AIBN is added into an electrolyte of the 18650 cylindrical battery, hence forming a lithium battery according to the fourth embodiment of the disclosure, which then undergoes the electrical property verification. FIG. 3 is an analysis diagram of charging and discharging characteristics of a lithium battery according to a fourth embodiment of the present invention. FIG. 3 indicates the same result, which is close to the theoretical capacity 1.8 Ah, and the capacity is more converged under different discharge rates. The discharge with a high current does not cause an obvious capacity loss, which proves again that the presence of the AIBN does not affect the battery features at the room temperature, and the polymerization reaction of the AIBN will not be induced.

Battery Alternating Current Impedance Test

The magnitude of the impedance of the SEI film is analyzed by using an alternating current impedance meter. FIG. 4 is diagram of an analysis on alternating current impedance of an SEI film of a lithium battery according to a third embodiment of the present invention. Through comparison, FIG. 4 shows the impact of the added AIBN on the battery impedance. At the condition of 100 KHZ-0.1 HZ and 5 mv/sec, the alternating current impedance test in a lithium battery system added with AIBN according to the third embodiment of the present invention shows that after the secondary formation by means of charging and discharging at the rate of 0.1 C, the charge transfer resistance (R_{CT}) of the electrolyte of the lithium battery according to the third embodiment of the present invention is minimum, which is much better than the conventional lithium battery, indicating that few passivation material inside the lithium battery according to the third embodiment of the present invention is precipitated on the surface of an electrode plate; therefore, an even ion transmission layer is formed and the lithium transmission is enhanced; meanwhile, the electrode plate surface is protected from structural disintegration.

X-Ray Photoelectron Spectroscopy (XPS) Surface Element Analysis

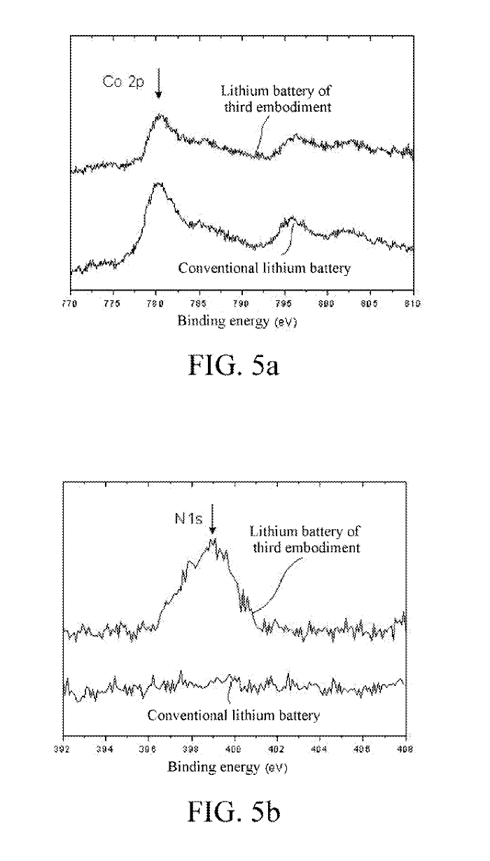

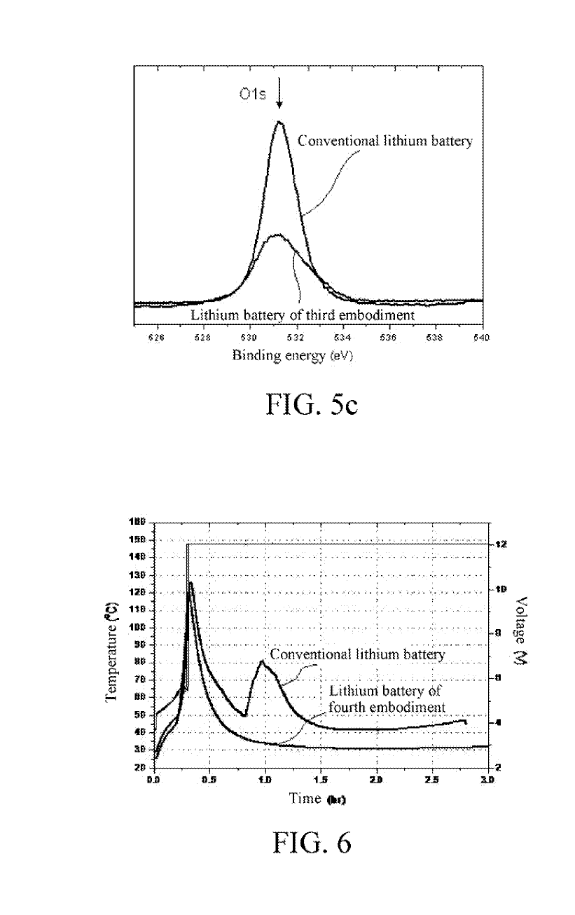

The element composition of electrode plate is analyzed using an XPS. The lithium battery according to the third embodiment of the present invention added with AIBN is dismantled so as to take out the anode (LiCoO2); the LiCoO2 is washed by a solvent for several times, and the surface elements and pattern thereof are analyzed. FIG. 5a is an XPS analysis diagram of a cobalt element (Co2p) on a surface of an anode material of a lithium battery according to a third embodiment of the present invention; FIG. 5b is an XPS analysis diagram of a nitrogen element (N1s) on a surface of an anode material of a lithium battery according to a third embodiment of the present invention; and FIG. 5c is an XPS analysis diagram of an oxygen element (O1s) on a surface of an anode material of a lithium battery according to a third embodiment of the present invention. The abscissa axis represents the binding energy of the electron obit. Because an atom of a specific state has fixed binding energy and hence has a corresponding signal peak, the type of the energy level of an atom can be acquired according to the signal peak.

As shown in FIG. 5a, the anode is a lithium cobalt oxide, so a cobalt element is detected at the anode; the signal of the cobalt element (Co2p) of the electrolyte in the third embodiment is weak, which proves that the anode surface has a protection film; the protection film contains a nitrogen element, which is proved in FIG. 5b. On the contrary, the conventional electrolyte does not have a protection film, and contains more oxide, as shown in FIG. 5c.

As shown in FIG. 5b, the nitrogen element is detected in the AIBN-containing electrolyte of the lithium battery according to the third embodiment of the present invention. The nitrogen element comes from the component of the AIBN, which proves that the AIBN undergoes a polymerization reaction with the ethylene or carbonate, and is precipitated at the anode surface, thereby forming the protection film layer on the anode.

In addition, it is analyzed whether the AIBN-containing electrolyte of a LiCoO₂/Li button cell and the conventional electrolyte of the lithium battery have an oxygen element. According to FIG. 5c, the electrolyte of the lithium battery according to the third embodiment of the present invention has much lower oxygen content than the electrolyte of the lithium battery. Therefore, the electrolyte of the lithium battery according to the third embodiment of the present invention only has little oxygen, which means that the electrolyte contains less oxide. The reason lies in that the protection film layer insulates a related solvent or the lithium salt, thereby preventing oxidization. It can be learned that the electrolyte of the lithium battery according to the third embodiment of the present invention is more stable than the conventional electrolyte of the lithium battery.

Battery Overcharge Safety Test

The temperature rise of the initiator-containing electrolyte of the lithium battery is tested through overcharge safety verification. The effect of the additive in improving the battery safety is verified by carrying out an overcharge test. The lithium battery according to the fourth embodiment of the present invention is rapidly overcharged to 12 V at the rate of 3 C, and the change of the battery temper rise is monitored.

FIG. 6 is a diagram of overcharge safety verification on a lithium battery according to a fourth embodiment of the present invention. According to FIG. 6, when the lithium battery is overcharged, the lithium battery without an initiator reaches a highest temperature of 128° C., and undergoes a second-phase temperature rise reaction, and reaches a temperature of 80° C.; it is difficult to return to the normal temperature afterwards.

However, the temperature of the electrolyte of the lithium battery according to the fourth embodiment of the present invention rises to 120° C. at most, and does not undergo a second-phase temperature rise; afterwards, the temperature quickly returns to normal, hence preventing the thermal energy from continuously accumulated inside the battery, and avoiding thermal runaway. Therefore, it is proved that the addition of the initiator can effectively cut off the transmission of lithium ions. In other words, when the temperature is higher than 80° C., the polymerization reaction with a safety mechanism is enabled, and the temperature is thus controlled.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An additive of an electrolyte of a lithium battery at least comprises an initiator, wherein the initiator is decomposed at a temperature higher than a default temperature to generate free radicals.

2. The additive according to claim 1, wherein the initiator has a functional group of —N═N— or —O—O—.

3. The additive according to claim 1, wherein the initiator is azodiisobutyronitrile (AIBN) or benzoyl peroxide (BPO).

4. The additive according to claim 1, wherein the default temperature is 60-120° C.

5. An electrolyte of a lithium battery, at least comprising:
the additive according to claim 1;
a carbonate; and
a lithium salt.

6. The electrolyte of a lithium battery according to claim 5, wherein the carbonate is selected from the group consisting a cyclic carbonate, a chain carbonate, and an ester derivative.

7. The electrolyte of a lithium battery according to claim 5, wherein the carbonate is selected from the group consisting of ethyl methyl carbonate (EMC), diethyl carbonate (DEC), dimethyl carbonate (DMC), ethylene carbonate (EC), propylene carbonate (PC), and γ-butyrolactone (GBL).

8. The electrolyte of a lithium battery according to claim 5, wherein the lithium salt is one selected from lithium salts with a central atom being selected from the group consisting of C, N, B, and Al.

9. The electrolyte of a lithium battery according to claim 5, wherein the lithium salt is selected from the group consisting of LiPF₆, LiBOB, LiBF₄, and LiClO₄.

10. The electrolyte of a lithium battery according to claim 5, wherein content of the additive accounts for 0.05˜10 wt % of the total electrolyte of a lithium battery.
